(19) United States
(12) Patent Application Publication
(10) Pub. No.: US 2011/0039047 A1
(43) Pub. Date: Feb. 17, 2011

(54) SYSTEM AND METHOD FOR FORMING THERMOPLASTIC-COMPOSITE TUBING

(76) Inventors: William V. Carson, Avon, OH (US); Rocco T. DeAngelis, Avon, OH (US); George Bielert, Avon, OH (US); Nick Walmsley, San Diego, CA (US)

Correspondence Address: MCDONALD HOPKINS LLC, 600 Superior Avenue, East, Suite 2100, CLEVELAND, OH, 44114-2653, US

(21) Appl. No.: 12/749,089

(22) Filed: Mar. 29, 2010

Related U.S. Application Data
(60) Provisional application No. 61/164,190, filed on Mar. 27, 2009.

(51) Int. Cl. B32B 1/08; B29C 70/10

(52) U.S. Cl. 428/36.3; 428/36.4; 156/149

(57) ABSTRACT

A system and method for forming thermoplastic-carbon fiber composite tubing is described. A non-continuous thermoplastic-carbon fiber composite sleeve capable of being formed into a tubular product, a method for forming a tubular product, and a tubular product fabricated from thermoplastic-carbon fiber composite is described. The sleeve may include at least one non-continuous thermoplastic fiber strand that may be interwoven with at least one carbon fiber. The method may include the steps of weaving the material into at least one sleeve to be processed, positioning a bladder within the sleeve to create a work piece, and placing the work piece in a mold. The mold may be heated and the bladder may be pressurized to form a tubular product. The resulting tubular product may be fabricated from thermoplastic carbon fiber composite with improved physical properties.

### CROSS-REFERENCE TO RELATED APPLICATION

This application claims benefit from U.S. Provisional Patent Application No. 61/164,190, entitled “System and Method for Forming Thermoplastic-Composite Tubing,” filed on Mar. 27, 2009, which is hereby incorporated by reference in its entirety.

### FIELD OF THE INVENTION

The present invention is generally related to a system and method for forming thermoplastic-carbon fiber composite tubing.

### BACKGROUND

Currently, it is very difficult to make tubular shaped products using thermoplastic compositions, such as carbon fiber thermoplastic composites. The thermoplastic resin may have a very high melt temperature and may be processed around 310-340° Celsius. This high processing temperature may create significant difficulties during manufacturing, as there is very little knowledge available to tackle this niche. In addition, there may be very little industry knowledge available to support such demands.

Typically, separate tube shaped composite components are mated together to form the square shaped tube structures. This “double clamshell” approach is less than ideal for a number of reasons. First and foremost is the scrap rate associated with such a process. By using two clamshells combined to make a tubular section there is effectively scrap around every single edge of both pieces. With the high cost of carbon fiber composites, this scrap rate is unacceptable and drives costs significantly higher. Scrap rates associated with this style process may be as high as 25%.

There also may be significant structural issues associated with a double clamshell construction. The single glue seam may be loaded in shear and peel. The proper way to load composites is by using the strength of the fiber to carry the load. Double clamshell structures must be carefully designed to avoid this type of loading. A better approach may be to load the fiber completely and continuously by eliminating these seams.

For example, by using a braided sock or sleeve the design may be inherently stronger as the load is carried through the fibers, and not exclusively through a glue joint. The scrap rate may also be much more favorable with a braided sleeve as the ends are the only source of scrap, there are no edges along the length of the part. Double clamshell methods may also be weight sensitive. Combining two shells together may often create a large glue seam where there is extra material and glue.

In the airline industry, conventional seats and seat back frames have been formed from metals such as aluminum. Such conventional frames have a number of drawbacks. For example, they have numerous and costly components that contribute to excessive assembly time and increased cost. Also, they are often difficult to form the complex geometry required by to accommodate both the contours of the passenger as well as any devices such as trays, phones, monitors, and the like. Furthermore, the overall weight of each conventional frame increases the overall weight of an airplane, thereby decreasing fuel efficiency.

While there have been attempts to replace aluminum parts and materials with composite materials, those composite materials have not achieved the desired properties possessed by aluminum. These desired properties are typically, but not limited to, material cost, physical properties, and ease of machining and forming, that may result in faster and less expensive processing. In general, composites may already be widely used, but they have not crossed into this more efficient processing arena. Such composite materials are also typically thermosets that could pose potential safety issues regarding use on airplanes.

While traditional thermoset composites may be used in the airline industry, they are time consuming to process and this severely impacts cycle times and ultimately throughput suffers. Recently, thermoplastic composites have become more readily available. Manufacturers have realized the amount of time saved by using short heat cycle times as well as the physical properties that are inherent to thermoplastics. For example, the double clamshell approach may be used to design seat backs, however, this approach typically results in a glue seam, as described above, of about fifteen feet. This may add as much as a quarter or a half pound to the weight of a seat. With weight reduction at such a premium, this is highly unacceptable in the airline industry.

Thermoplastic composite parts resulting from these new processing methods may also be required to have certain physical proprieties in order to pass stringent safety standards of the transportation industry, such as the airline industry. For example, in the airline industry, a seat back frame may be pulled for at least 70,000 cycles in a rearward direction until a pressure of at least 168 psi is reached each time. The seat back frame may also be required to pass a test where the frame may be pulled on one time with 300 pounds of force.

It is very difficult to make tubular shaped products using thermoplastic compositions, such as carbon fiber thermoplastic composites, that may withstand high load and bending requirements including certain dynamic testing and compliance with head injury criteria (HIC) and femur load requirements, such as the requirements of CS 25.562 according to Advisory Circular AC 25.562 from the Federal Aviation Administration (FAA). These tests verify that the seat back frame will not have any breaks, cracks or the like during the lifetime of an aircraft. These tests may also track how much the seat back frame bends or the angle of deflection from start to finish. There are no known tubular components comprising thermoplastic carbon fiber composites that include the physical properties and characteristics that may address these issues and testing requirements.

Aircraft interior components is a demanding and unique manufacturing market, particularly as related to manufacturing tubular structural components. Aircraft interior composite components may be defined by their unique material characteristics, high strengths, and low weights. Additionally, production volumes are high, and tooling is expensive, which may erode profit margins quickly. Therefore, it may be difficult if not impossible to find tubular structural components formed from thermoplastic carbon fiber composites that meet these unique material characteristics, high strengths and low weights that may also include the physical properties to withstand the necessary testing requirements.

For composites to be correctly utilized in the airplane industry, such as seat backs and tubular structural components of seat backs, the composite structure as well as the design and configuration of the composite parts comprising the seat or seat back must be combined in a way that takes advantage of their physical properties. There may be great value in a design that takes all of these factors into account. These needs have driven the development of thermoplastic composite braided sleeve seat back design as well as unique and uncharted processing methods.

### SUMMARY

A system and method for forming thermoplastic-carbon fiber composite tubing is described. A non-continuous thermoplastic-carbon fiber composite sleeve capable of being formed into a tubular product, a method for forming a tubular product, and a tubular product fabricated from thermoplastic-carbon fiber composite is described. The sleeve may include at least one non-continuous thermoplastic fiber strand. The non-continuous thermoplastic fiber strand may be interwoven with at least one carbon fiber, wherein the carbon fiber is positioned at an angle different from the thermoplastic fiber strand.

The method for forming a tubular product from a thermoplastic-carbon fiber composite may include weaving a plurality of non-continuous thermoplastic fiber strands with carbon fiber strands to form at least one sleeve to be processed and positioning a bladder within the at least one sleeve to create a work piece. The work piece may be placed in a mold. The mold may be heated and the bladder may be pressurized. After which the work piece may be removed from the mold.

The tubular product may be fabricated from thermoplastic-carbon fiber composite. The tubular product may include a braided sleeve comprising at least one non-continuous thermoplastic fiber strand interwoven with a carbon fiber strand at an angle different from the non-continuous thermoplastic fiber strand. There may be a plurality of sleeves interwoven at a first angle relative to each other and a plurality of sleeves interwoven at a second angle relative to each other. At least one layer of the sleeves at the first angle may be layered with at least one layer of the sleeves at the second angle, wherein the layers may form the tubular product. The tubular product may have improved physical properties.

### BRIEF DESCRIPTION OF THE DRAWINGS

Objects and advantages together with the operation of the invention may be better understood by reference to the detailed description taken in connection with the following illustrations, wherein:

FIG. 1 illustrates a block diagram of a system and method for forming thermoplastic composite tubing.

FIG. 2 illustrates a block diagram of a system and method for forming thermoplastic composite tubing.

FIG. 3 illustrates a block diagram of a system and method for forming thermoplastic composite tubing.

FIG. 4 illustrates a perspective view of a work piece in accordance with a non-limiting illustrative example.

FIG. 5 illustrates a close up perspective view of an end of the work piece of FIG. 4 and a detail view of a portion of the sleeve.

FIG. 6 illustrates a close up perspective view of a sleeve in accordance with a non-limiting illustrative example and a detail view of a portion of the sleeve.

FIG. 7 illustrates a perspective view of a work piece in a lower portion of a mold in accordance with a non-limiting illustrative example.

FIG. 8 illustrates a close up perspective view of an end of the work piece and mold of FIG. 7.

FIG. 9 illustrates an exploded perspective view of a work piece in a mold in accordance with a non-limiting illustrative example.

FIG. 10 illustrates an assembled perspective view of a work piece in a mold in accordance with a non-limiting illustrative example.

FIG. 11 illustrates a cross-sectional view of the work piece in the mold of FIG. 10.

FIG. 12 illustrates a perspective view of a finished product that may be manufactured utilizing the method of FIG. 3.

FIG. 13 illustrates a side view of the finished product of FIG. 12.

FIG. 14 illustrates a top view of the finished product of FIG. 12.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

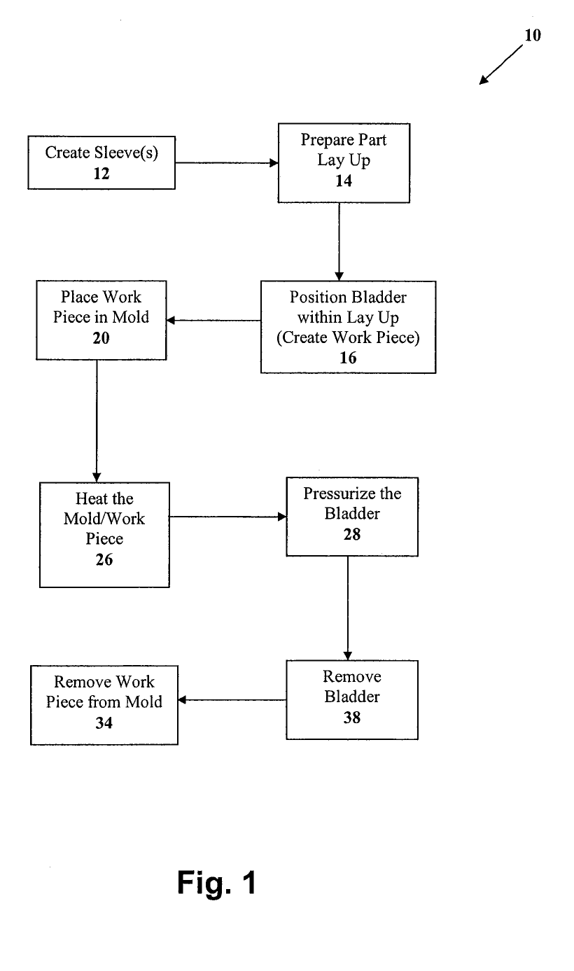

A system and method 10 for forming thermoplastic-carbon fiber composite parts is illustrated in FIGS. 1-3. The system and method 10 may utilize a braided or woven plastic sock or sleeve 50 to form the desired finished product or part (FIG. 6). Traditionally, a plastic sock or sleeve has not been used in the airline industry, nor has it been used with high performance (semi-crystalline) thermoplastics, such as polyphenylene sulfide (PPS), polyetheretherketone (PEEK) or polyetherketoneketone (PEKK) matrices, that may meet flame, smoke and toxicity requirements.

The method 10 may include creating a sleeve (12) (FIGS. 1-3). The material to be formed or processed by the method 10 may initially be provided as a bundle of threads or strands 46 that may then be put through a braiding or weaving machine to create the sleeve or sock 50 (FIGS. 5 and 6). The threads or strands 46 may be of any appropriate size, shape or length. It is to be understood that the sleeve 50 may be of any appropriate size or diameter. The sleeve 50 is also very conformable to different formed shapes. While the present method 10 is shown and described as utilizing a sock or sleeve 50, it is to be understood that any appropriate shape, type or configuration of the material may be utilized and should not be limited to that shown or described herein.

The sleeve 50 may be fabricated by any appropriate process, such as being fabricated from continuous fibers, chopped fibers, non-continuous or stretch broken fibers or the like. For example, the sleeves 50 may be comprised of woven fibers or strands 46 (FIGS. 5 and 6). It is to be understood that the starting materials may be of any appropriate material, including, but not limited to, dry fiber and resin or pre-impregnated tape, for example.

The process of fabricating a stretch broken fiber sleeve 50 may begin by providing a long, solid and continuous strand (e.g., as shown with the following continuous line “______”). This solid strand may exhibit strength from one end to the other, from left to right. This continuous type of fiber, however, may be somewhat difficult to form into certain shapes due to the strength of the fiber running in one direction. Next, that strand of continuous fiber may be chopped into small pieces (e.g., as shown with the following dashed line“- - - ”). Once in this chopped state, the individual pieces of fiber may be re-aligned, whereby these chopped pieces may give the appearance of a solid strand of fiber, but remain broken (e.g., as shown with the following dotted line“• • • ”). This strand 46 of stretch broken fiber may provide the same strength properties as the continuous fiber strand, such as from left to right, but may also provide more formability in different and varying directions due to the fiber strand being stretch broken.

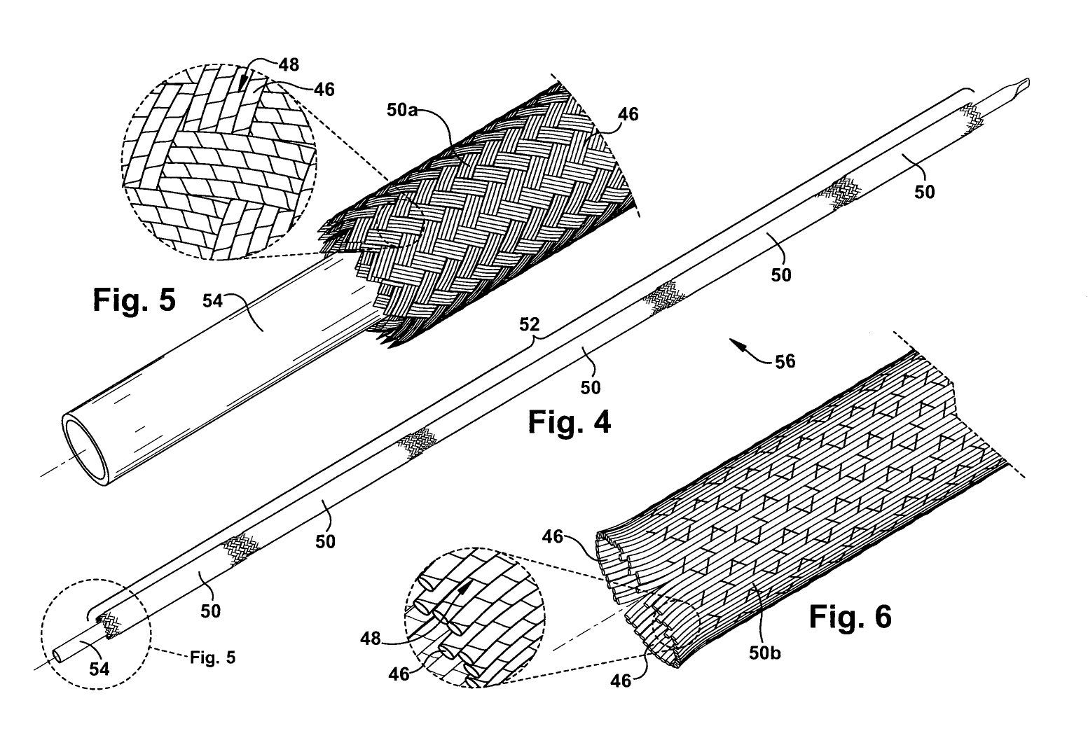

Each grouping of strands 46 that makes up the sleeve 50 may be fabricated out of any appropriate type of material, such as a thermoplastic. For example, each strand 46 may be fabricated out of PPS. Each of these strands 46 may also be interwoven or individually wrapped around with any appropriate type of fiber 48, such as a carbon fiber (FIGS. 5 and 6). The strands 46 may be woven in any appropriate manner, configuration or angle. For example, the strands 46 of a first sleeve configuration 50a may be woven in a 45° angle (FIG. 5). The strands 46 of a second sleeve configuration 50b may be woven in a 0° angle (FIG. 4). The sleeves 50 may be of any appropriate shape, size or length. The sleeves 50 may also be of varying shapes, sizes and lengths.

The sleeves 50 may be placed over a guide or form, such as a mandrel (not shown). The mandrel may be of any appropriate shape or size, such as a flat or round piece of material. The mandrel may be fabricated out of any appropriate type of material, such as steel or plastic. One type of mandrel may be a shaped bar of metal inserted in, or next to, an item to be machined or formed in a certain pattern. The mandrel may be an object used to shape a piece of work or prepare a lay up 52. For example, the mandrel may allow the work piece to be bent into smooth curves without undesirable creasing, kinking, or collapsing.

Any appropriate number, types or configurations of sleeves 50 may be utilized to form the desired part or finished product. In addition, any appropriate number of layers may be utilized to form the desired part. The method 10 may involve preparing a part lay up (14) (FIGS. 1-3). For example, a work piece lay up 52 may be comprised of several different layers of sleeves 50 or layers of varying types of sleeves 50a, 50b (FIG. 4). The lay up 52 may also include layers of sleeves 50 that may be of various different lengths (FIGS. 4 and 5). The layers of sleeves 50 may be arranged in any appropriate manner or configuration.

In a non-limiting example and for illustrative purposes only, the lay up 52 may include a first layer of the first sleeve configuration 50a (i.e., a sleeve woven at a 45° angle) of about 63 inches long may be slid or placed over the mandrel. Next, a second layer of the second sleeve configuration 50b (i.e., a sleeve woven at a 0° angle) of about 63 inches long may be placed over the first layer. A third layer of the first sleeve configuration of about 63 inches long may be placed over the second layer. Next, a layer of the first sleeve configuration of about 21 inches long may be placed over each end of the third layer. Lastly, a layer of the first sleeve configuration of about 8 inches long may be placed over each end of the fourth layer to finish the lay up 52. Once the lay up 52 has been completed, the mandrel may be removed from the sleeve lay up 52.

The method 10 may further include positioning a bladder within the lay up to create a work piece (16) (FIGS. 1-3). For example, while or after removing the mandrel, a bladder 54 may be inserted in place of the mandrel, thereby creating the work piece 56 (e.g., the sleeves 50 and the bladder 54) (FIG. 4). The bladder 54 may be fabricated out of any variety of appropriate materials. For example, the bladder 54 may be fabricated out of polytetrafluoroethylene (PTFE), which is a synthetic fluoropolymer of tetrafluoroethylene. The PTFE bladder may be pre-shrunk, whereby it may expand to four times it seize to force out the walls of the work piece.

As another option, a PEEK bladder may be used within the sleeve 50. Utilizing a PEEK bladder may be appropriate in terms of holding the desired temperature and pressure for any sustained period of time. Alternatively, a silicone or silicone blended bladder may also be used depending upon the type of silicone and temperature being used. For example, high temperature silicone or platinum cure silicone may be used. Platinum cure silicone may be an appropriate choice for temperatures up to 750° Fahrenheit.

The bladder 54 may be of any appropriate type or configuration, such as a high temperature bladder. The bladder 54 may be of any appropriate shape or size, such as a cylindrical shape that may be of any appropriate length. For example, the bladder 54 may be about 72 inches long. The bladder 54 may also be larger than the diameter of the part to be molded. Typically, a PEEK bladder may not expand as it tends to be brittle at the required temperature, such as 600° Fahrenheit. The bladder 54 may often need to be oversized in comparison to the part thereby allowing wrinkles to form on the inside of the sleeve 50, which does not affect the resulting part.

As the sleeve 50 and bladder 54 material may be flexible, the work piece 56 may be bent in any appropriate direction or angle and placed into any appropriate configuration to create the desired finished product or part 74. The bladder 54 may be located at any appropriate or desired location within work piece 56, such as at any appropriate location within the sleeve 50 in order to form the desired part or reach the desired outcome.

The ability to uniformly apply pressure to complex shaped parts may be a factor for utilizing a bladder 54. It may be best to fit the bladder 54 as close to the inside or inner portion of the lay up 52 as possible. Occasionally, bladders may not expand evenly under pressure and may stick to random areas of the lay up 52, which may result in some sections of the bladder 54 expanding to fit small areas of the cavity and exceeding the ultimate elongation. Narrow or thin areas or areas with sharp angles on parts are the most critical.

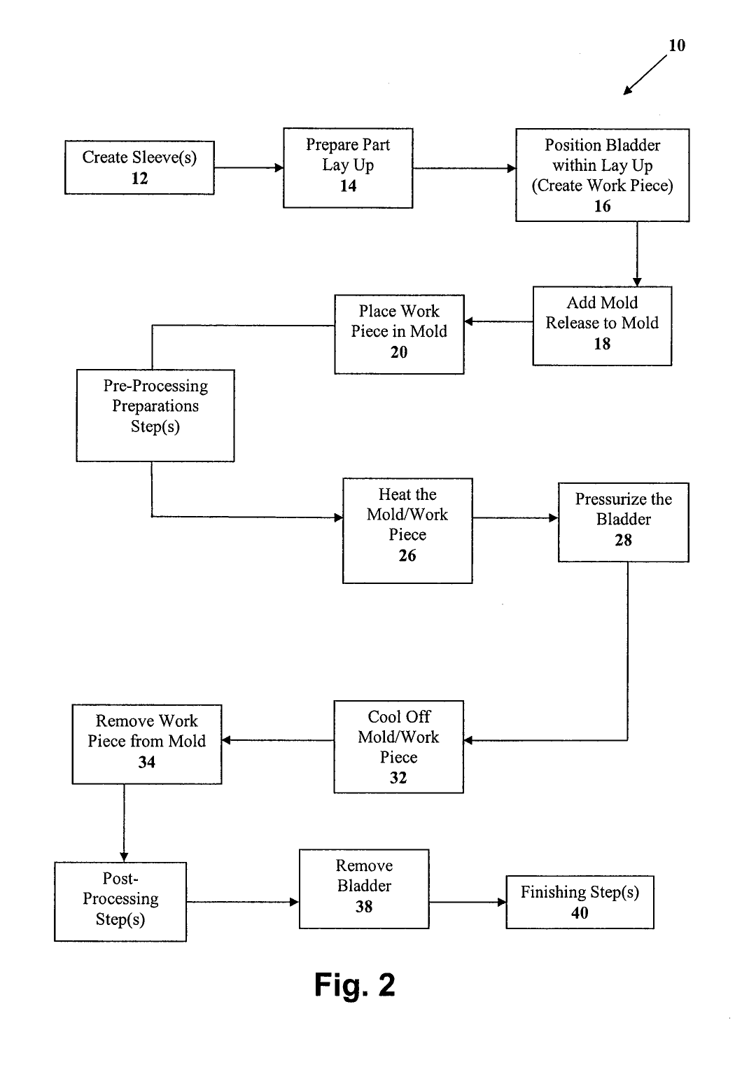

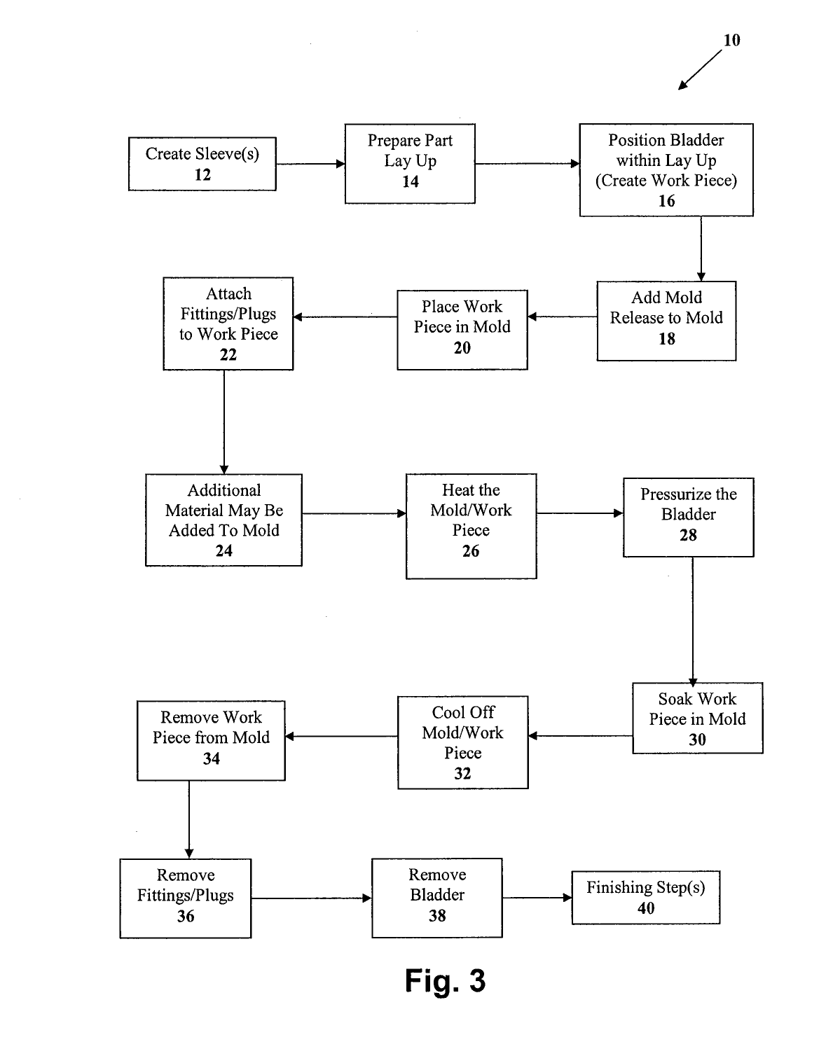

The method 10 may optionally include preparing a part lay up (18) (FIGS. 2 and 3). For example, the mold 64 may be treated with a mold release (not shown). The mold release may be of any appropriate type or form, such as a spray or a wipe on mold release. The mold release may prevent the work piece 56 or finished product 74 from sticking to the mold 64. The mold release may withstand the temperatures being used and aid in removing the work piece 56 from the mold 64 after processing. For example, Loctite® Frekote® 710-NC may be used as the mold release agent.

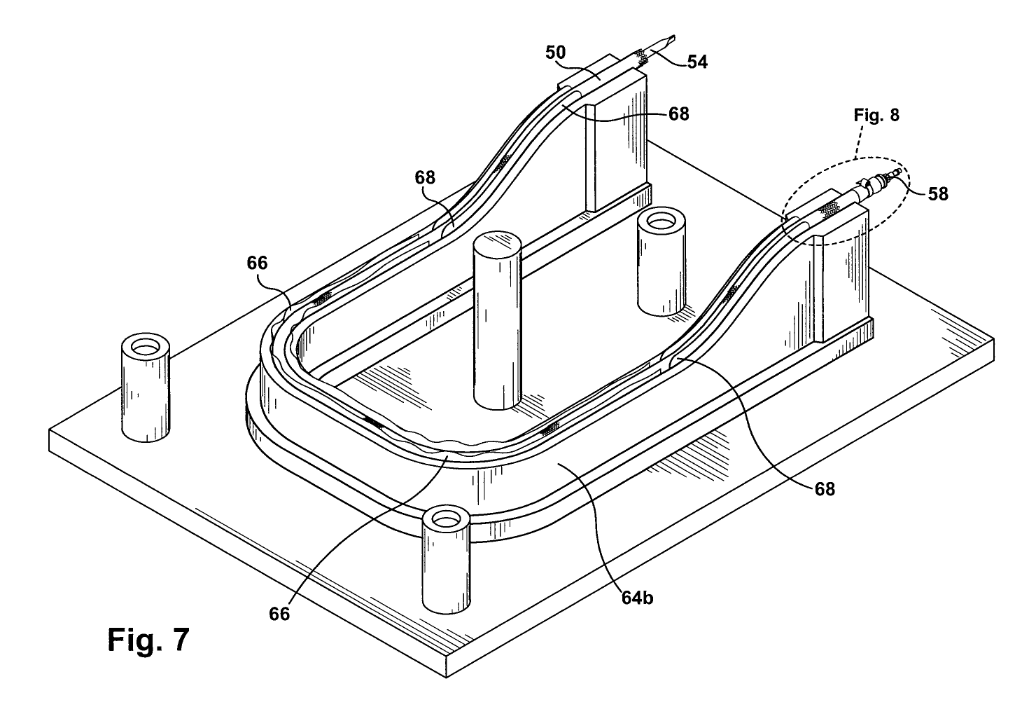

The method 10 may also include placing the work piece in a mold (20) (FIGS. 1-3). For example, once the bladder 54 is positioned within the sleeve(s) 50 of the work piece 56, the work piece 56 may be placed into a mold 64 (FIGS. 7 and 9). While the method 10 is described with the bladder 54 being positioned within the work piece 56 prior to the work piece 56 being placed within the mold 64, it is to be understood that this procedure may be reversed, whereby the work piece 56 may be placed into the mold 64 prior to the bladder 54 being placed within the work piece 56.

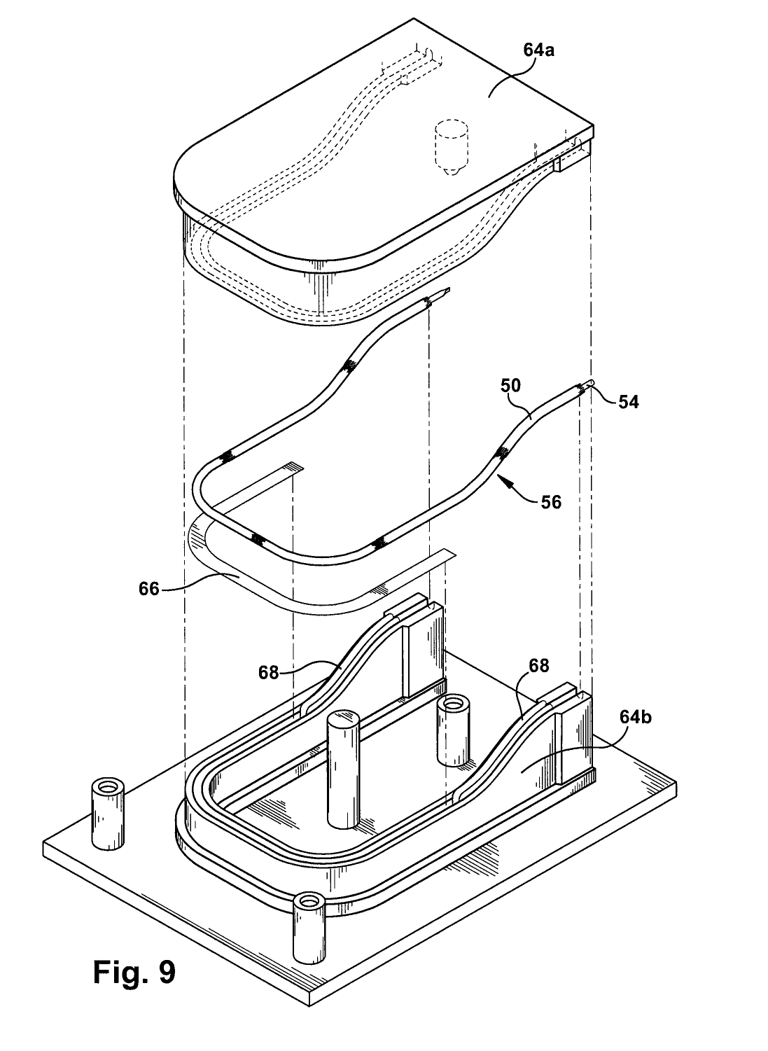

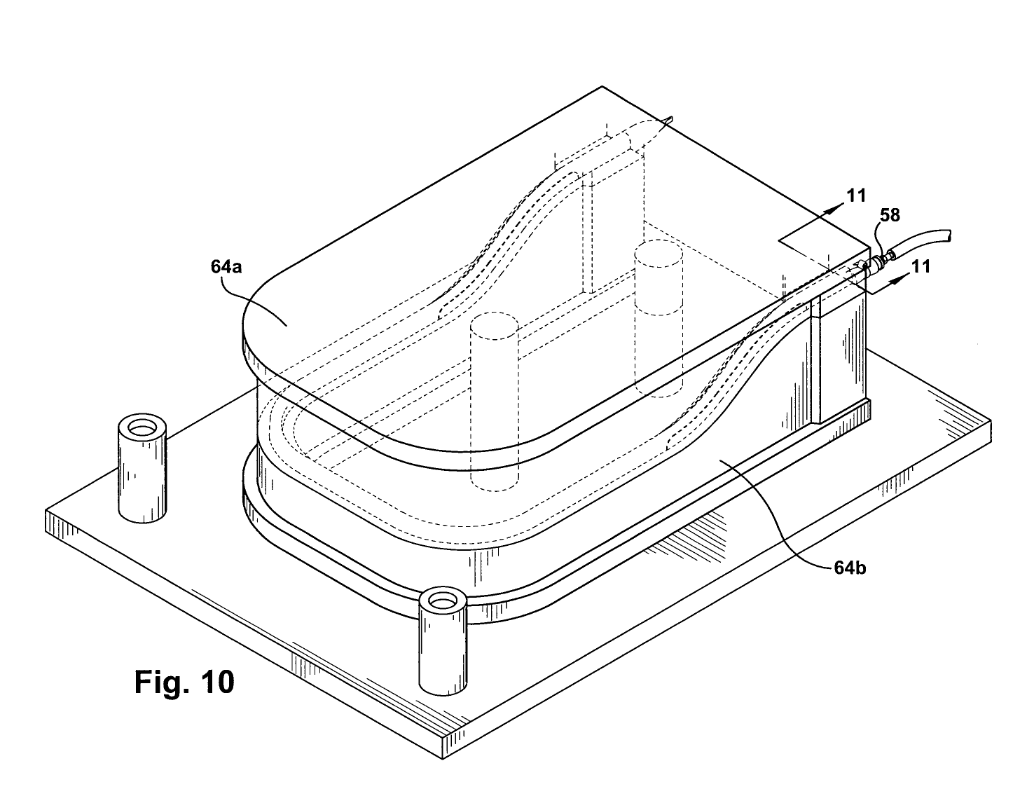

The mold 64 may be of any appropriate shape, size, type or configuration. For example, the mold 64 may be of a generally square, rectangular or ovular shape (FIGS. 7, 9 and 10). The mold 64 may include any appropriate number of portions. For example, the mold 64 may include an upper or top half 64a and a lower or bottom half 64b that may fit together (FIGS. 9-11). The mold 64 may be fabricated out of any appropriate type of materials, such as steel or aluminum.

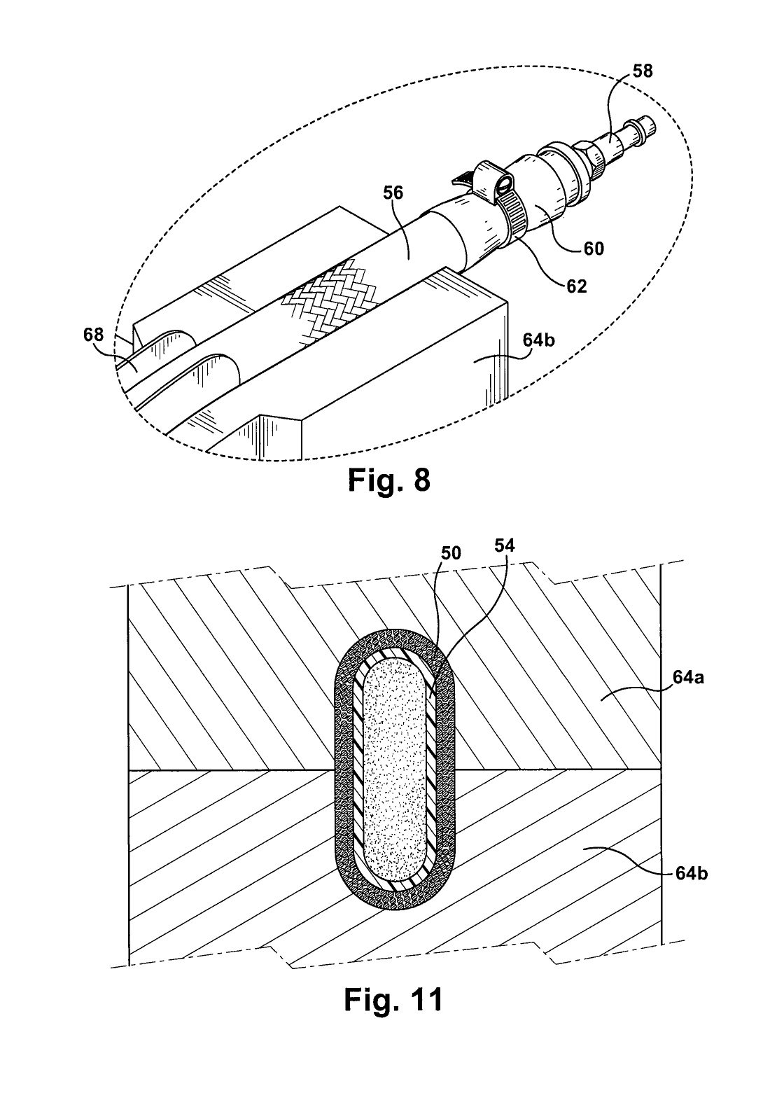

The method 10 may include attaching fittings or plugs to the work piece (22) (FIG. 3). For example, once the bladder 54 is inserted, any pre-processing actions may be performed. After being placed in the mold 64, any appropriate type of fittings 58 may be placed over an end of the work piece 56, such as one or both (FIG. 7). For example, an air fitting 58 may be placed over a first end of the work piece 56 (FIG. 8). The air fitting 58 may be of any appropriate shape, size or type. A plug (not shown) may be placed over or within a second end. The plug may be of any appropriate shape, size or type. The air fitting 58 may allow air to enter the bladder 54 and the plug may keep the air within the bladder 54.

The air fitting 58 and plug may be placed on the work piece 56 after the work piece 56 is placed in the mold 64. This may ensure that the air fitting 58 is not inserted too far into the mold 64 in order to prevent too much heat from being applied to the air fitting 58. While the method 10 may be described as having the fitting 58 and plug placed over or within the work piece 56 prior to the work piece 56 being placed within the mold 64, it is to be understood that the work piece 56 may be placed in the mold 64 prior to the fitting 58 and plug being placed on or within the work piece 56. For example, the bladder 54 may be placed within the work piece 56 and then the work piece 56 may be placed in the mold 64, whereby the fitting 58 and plug may be attached.

The ends of the work piece 56 may be wrapped in additional protective material 60 (FIG. 8). The protective material 60 may be of any appropriate shape, size or type. For example, the protective material 60 may be fabricated out of high temperature silicone strips. The strips 60 may be wrapped around each end of the work piece 56. The strips 60 may be tightened on each end of the work piece 56 by any appropriate means, such as with a fastener 62. Any appropriate type of fastener 62 may be used, such as a circular clamp (FIG. 8). These strips 60 may also provide additional protection for the fitting 58 and plug during processing.

The method 10 may include adding additional material to the mold (24) (FIG. 3). For example, additional material(s) may also be added to and located within the mold 64. These additional materials may be applied to enhance or improve the finished product 74. The additional material may be located at any appropriate position within the mold 64. For example, the material may be located between the mold 64 and the work piece 56. The additional material may be any appropriate type of material(s), shape, size, type or configuration. For example, the additional materials may include strips of film 66 and pad ups 68 (FIGS. 7 and 9).

The strips of film 66 may be of any appropriate shape or size and be fabricated out of any appropriate type of material, such as being strips of PPS resin film 66 (FIGS. 7 and 9). The strips of film 66 may be located between the mold 64 and the work piece 56. The strips of film 66 may be located at any appropriate position around the work piece 56, such as towards a central portion of the work piece 56. The film 66 may provide a PPS resin rich environment during the fabrication process. The film 66 may also aid in providing a smoother finish and appearance to the finished product 74.

One or more pad ups 68 may also be added to and located between the mold 64 and the work piece 56 (FIGS. 7-10). The pad ups 68 may be of any appropriate shape, size or type and be fabricated out of any appropriate type of material. For example, each pad up 68 may be about 10 inches long. There may be any appropriate number of pad ups 68, such as two on each leg. The pad ups 68 may be located at any appropriate position on the mold 64, such as adjacent each end of the work piece 56 located within the mold 64. The pad ups 68 may provide extra strength to any appropriate part of the work piece 56, such as the ends of the work piece 56.

The method 10 may also include heating the mold and work piece (26) (FIGS. 1-3). Once the work piece has been placed within the mold 64, the mold 64 may be heated up. The mold 64 may be heated by any appropriate means. For example, the mold 64 may include any appropriate number of heater rods (not shown) to heat the mold 64 and work piece 56. The heater rods may be inserted into the mold 64. There may be any appropriate number of heater rods. The heater rods may permit heat to enter into the mold 64 to heat up the work piece 56.

The heater rods may be located at any appropriate position on or in the mold 64, whereby the heater rods may be placed in a generally spaced relationship to each other and located around the mold 64. The heater rods may permit each area or zone of the work piece to be heated to and maintain the approximately similar temperature throughout the mold 64, whereby the mold 64 temperature does not fluctuate more than 15-20° Fahrenheit from one zone to another. The heater rods located in the top half of the mold 64 may be powered and controlled separately from the heater rods located in the bottom half of the mold 64.

The mold 64 may be heated until the work piece 56 reaches the desired temperature. The desired temperature may vary based upon the material used. A typical operating temperature range may be between about 580-650° Fahrenheit. For example, the mold 64 may be heated until the work piece 56 reaches about 600° Fahrenheit.

When determining the appropriate temperature, the viscosity profile of the material, such as a PPS material, may be looked at. PPS materials may often require temperatures above 590° Fahrenheit or ideally between 600-650° Fahrenheit to process the PPS material. Once the part has been molded, the part may need to cycle between 600° Fahrenheit and lower, by 50-100° Fahrenheit to lower than 400° Fahrenheit.

The method 10 may further include pressurizing the bladder (28) (FIGS. 1-3). After the work piece 56 is placed into the mold 64, the work piece 56 may be pressurized within the mold 64 to any appropriate pressure to form the desired finished product 74. The bladder 54 may be pressurized at any appropriate time during the process 10. For example, once the work piece 56 temperature has reached about 550° Fahrenheit, the bladder 54 may begin to be pressurized 28. While the method 10 may be described as the work piece 56 being heated prior to being pressurized, it is to be understood that the work piece 56 may be pressurized first and then heated or the work piece 56 may be heated and pressurized at the same time, and should not be limited to that shown or described herein.

The bladder 54 may be pressurized by any appropriate means. For example, the bladder 54 may be pressurized with either an o-ring sealing device or with a flanged termination. There are dozens of variations of these two basic concepts. Most bladders 54 may terminate in a round tube, and that tube may be run through a bored hole in the mold. This may usually be done on the split line of the mold with the seal made with o-rings on a line-drilled rod or with the lay-up mandrel itself.

Another way to pressurize may be to terminate the bladder 54 with a flange type surface that works like a gasket. This gasket may be clamped between a surface on the mold and a flat plate with an air fitting supplies air to the cavity. The seal may be improved with an o-ring or bulb seal attached to one of the mating surfaces. The flange method may take more time to seal the bladder to the mold. Alternate air supply methods may include devices such as expanding rubber plugs in the mold 64 or hoses clamped directly to the bladder and restrained under pressure.

The bladder 54 may be pressurized to an appropriate pressure. While bladders 54 may be used with composite curing to over 300 psi, standard compressed air line pressures are more common, such as pressures of 40-50 psi. For example, the bladder 54 may be pressurized to about 80-90 psi. Bladders 54 may often burst because of fit problems, not from excess pressure. Molds 64 and fittings 58 used at the higher pressures must be designed accordingly. PPS may not require much pressure as the PPS may easily flow out and wets out the part, which is a common trait of infusion resins.

The method 10 may also include soaking the work piece in the mold (30) (FIG. 3). After the bladder 54 has been pressurized 28 and the temperature of the work piece 56 has been heated to the desired temperature 26, the work piece 56 may remain within the mold 64 to soak or sit (FIG. 10). As the work piece 56 is heated and pressurized, the work piece 56 may harden as the braided sleeve 50 material may melt together to form a rigid contiguous surface for the finished part 74. The method 10 may only require that heat be applied and may not require any additional time to form the finished part 74.

The work piece 56 may soak in the mold 64 at the required temperature, such as about 600° Fahrenheit, for the required time, such as approximately 10-15 minutes. For example, the work piece 56 may soak in the mold 56 at the required temp for about 10-15 minutes to give the fibers 48 and the matrix material or strands 46, such as the PPS, time to soften and take the shape of the mold 64.

The method 10 may include cooling off the work piece and mold (32) (FIGS. 2 and 3). After the work piece 56 has soaked within the mold 64, the heat or power may be turned off, whereby the work piece 56 and mold 64 may be cooled off as quickly as possible 32. The work piece 56 and mold 64 may be cooled off by any appropriate means, such as with fans. The bladder 54 may remain pressurized within the mold 64 while the work piece 56 cools in order to maintain the finished shape of the intended finished product 74. It may take any appropriate amount of time for the work piece 56 to cool off to a point where the work piece 56 may be handled. For example, it may take approximately 1 and ½ hours to cool to about 270° Fahrenheit.

The method 10 may include removing the work piece from the mold (34) (FIGS. 1-3). For example, once the work piece 56 has cooled 32 to a temperature that may be safely handled, such as with gloves, the work piece 56 may be removed from the mold 64. The method 10 may include removing the fitting and plug (36) (FIG. 3). For example, the air fitting 58 and plug may also be removed 34.

The method 10 may further include removing the bladder (38) (FIGS. 1-3). For example, the bladder 54 may be removed after the work piece 56 has been removed from the mold 64 and the fitting 58 and plug have been removed. It is to be understood that the air fitting 58 and plug may be removed prior to the work piece 56 being removed from the mold 64 or after the work piece 56 has been removed from the mold 64. It is also to be understood that the bladder 54 may be removed after the air fitting 58 and plug are removed, but prior to the work piece 56 being removed from the mold 64.

The method 10 may also include performing finishing measures (40) (FIGS. 2 and 3). After the bladder 54 is removed room the work piece 56 and the work piece 56 may be removed from the mold 64, the work piece 56 may receive any desired finishing. For example, each end of the work piece 56 that remained outside of the mold 64 during the heating process may still be comprised of the woven sleeve material. These unprocessed ends may received a finishing procedure, whereby each end may be trimmed or cut off to provide a smooth edge, thereby creating a finished part or product 74.

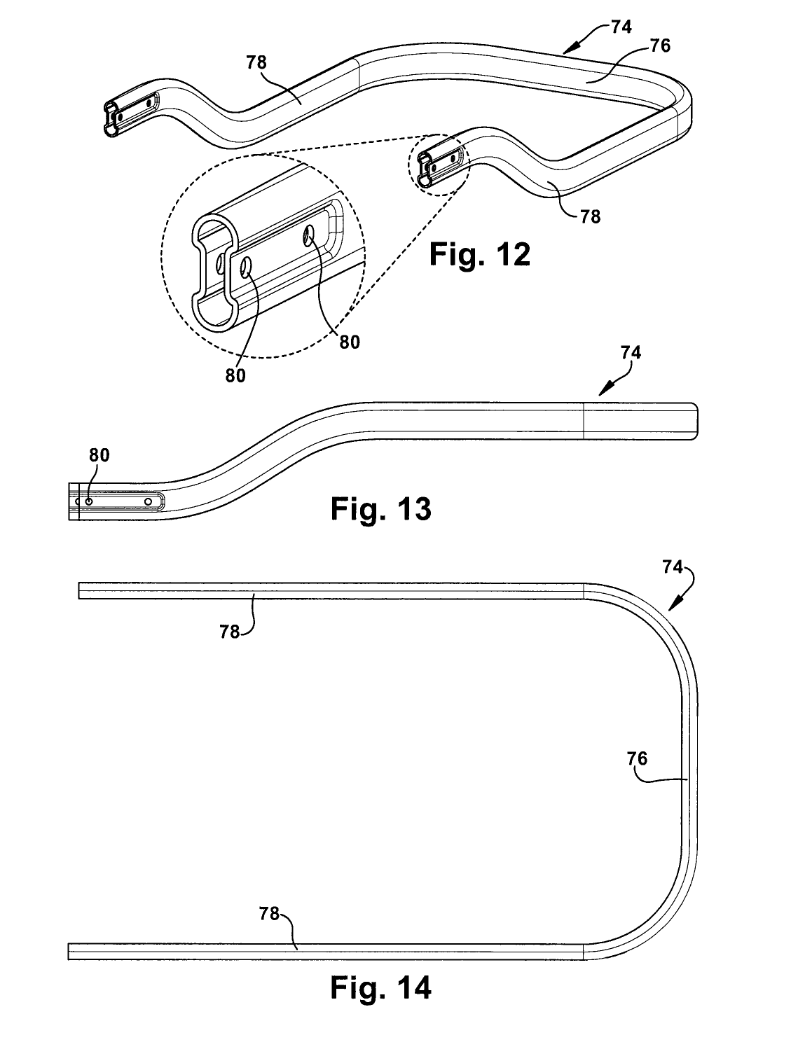

The finished part 74 may be of any appropriate shape, size, or configuration. For illustrative purposes only, in a non-limiting example the finished part 74 may include an upper or mid member 76 (FIGS. 12 and 14). The mid member 76 may be of any appropriate shape or size, such as of a generally square or rectangular tubular shape. The mid member 76 may also be of a generally planar or curved shape or a combination of the two.

The finished part 74 may also include one or more legs 78 (FIGS. 12-14). The legs 78 may be of any appropriate shape or size, such as of a generally square or rectangular tubular shape. The legs 78 may be located at any appropriate position on the finished part 74, such as on either end of the mid member 76. Each leg 78 may generally extend outward and away from the mid member 76. The legs 78 may also be of a generally planar or curved shape or a combination of the two. The legs 78 may be of a differing or similar shape or configuration.

The finished part 74 may also include any appropriate number of apertures 80 (FIGS. 12 and 13). These apertures 80 may accept any appropriate type of fasteners (not shown). The finished product 74 may be utilized with any appropriate type of support structure, such as a bracket. The support structure may be inserted into the opening of the finished part 74 and then be secured together. This assembly may be secured into an airplane or train to maintain the seat back in place.

The finished product 74 may have improved characteristics and physical properties. As a non-limiting example, the finished part 74 may be of a seat back frame. The frame 74 may carry the entire load of a seat and seat components in the frame alone. The frame 74 may not require any backing between the sides to pass the safety requirements.

The method 10 may be used to fabricate any appropriate type of part, such as any type of tubing or tubular part (FIGS. 1-3). The resulting part may be both lightweight and strong. The method 10 may be used to manufacture any appropriate type of part or component to be used anywhere on interior of an aircraft or other passenger vehicle, such as a train, and is in no way meant to be limited to the examples described herein. For example, the method 10 may be used for seat frames, seat beams, armrests, backrests, tables, and the like.

The sample finished part 74, such as a seat back frame, may be manufactured utilizing the method 10 (FIGS. 1-3 and 12-14). This resulting part 74 from the method 10 may eliminate the need for multiple components, as well as eliminate the need for any complicated assembly tools, which both result in cost savings, while also speeding up assembly time. The configuration and the composite structure of the finished part 74 may provide improved structural stability while decreasing the number of parts and overall weight of the finished part 74.

The finished part 74 may be formed from a composite material. While some composites may have found a home in the aircraft industry for some parts, in general, composites still have not met the challenges of providing low cost and highly manufacturable tubular structures, such as the seat back frame 74 fabricated from the method 10. As used herein, the term “composite” may be defined as highly-aligned reinforcements of carbon, glass, aramid fibers, and the like in a suitable polymer matrix of a thermoplastic resin.

The composite material may preferably include one or more ply layers, each ply having substantially unidirectionally aligned continuous fibers of carbon, glass, or aramid fibers in a polymer matrix of thermoplastic resins. Thermoplastic resins may include, but are not limited to, polybutyleneterephthalate (PBT), PPS, PEEK, PEKK, polysulfone (PS), polypropylene (PP), polyethylene (PE), ABS resin, thermoplastic elastomer, or a composite materials of these thermoplastic resins.

Thermoplastic composites may be reinforced with high-strength, high-modulus fibers that provide dramatic increases in strength and stiffness, toughness, and dimensional stability. Advantages of using thermoplastic composites as opposed to thermoset composites are their superior impact and damage resistance properties, high toughness and ease of recycling, which is increasingly important in the airline industry.

In contrast, thermoset composites are inherently brittle and cannot be usefully recycled. For instance, an advanced thermoplastic composite component can be chopped to pellet-size and injection-molded to yield long-fiber reinforced moldings, which can in turn be recycled at the end of their life. Thermoset composite materials, in contrast, can only be ground and used as filler, a process that decreases the value of the composite enormously. There may also be environmental issues associated with thermoset processing, as a chemical reaction is necessary to form the solid structure of the polymer (e.g., impregnation of the fibers is followed by chemical curing to give a solid structure, which is usually carried out isothermally). In contrast, with thermoplastics, the molding can be carried out non-isothermally (e.g., a hot melt into a cold mold) in order to achieve fast cycle times.

To prepare the composite material, the thermoplastic resins are compounded with composite or reinforcement materials, such as carbon fibers, glass fibers, or metal, so as to improve heat resistance, dimensional stability and rigidity. Glass fiber reinforced composites improve both short-term and long-term mechanical properties of a resin, including tensile modulus, dimensional stability, hydrolytic stability, and fatigue endurance. Deformation under load of these stiffer materials is also reduced significantly. Aramid fiber reinforced composites have low warpage, excellent wear and abrasion resistance, low coefficient of friction, and low thermal expansion. Although aramid fibers are stronger on a weight basis than steel or aluminum, they are not as easy to work with as compared to glass and carbon.

Carbon fiber composites have superior fatigue properties to known metallic structures, and when coupled with the proper resins, carbon fiber composites are one of the most corrosion resistant materials available. Carbon fiber is used to create materials that can withstand extremely high temperatures along with significant abrasive wear. Carbon fiber composites are stronger than steel, yet lighter.

In comparison to aluminum, carbon fiber composites are stronger, stiffer and lighter. Carbon fiber reinforced materials, at two to four times the cost of comparable glass-reinforced thermoplastics, offer the ultimate in tensile strength, stiffness, and other mechanical properties. Compared to the glass-reinforced materials discussed above, these compounds have a lower coefficient of expansion and mold shrinkage, improved resistance to creep and wear, and higher strength-to-weight ratios.

Accordingly, the finished product 74 may preferably include carbon fibers added to thermoplastic resins to provide the highest strength, modulus, heat-deflection temperature, creep, and fatigue-endurance values available in composites. These mechanical property improvements, coupled with increased thermal conductivity and low friction coefficients, make carbon fibers ideal for wear and frictional applications. In applications where the abrasive nature of glass fibers wears the mating surface, the softer carbon fibers can be substituted to reduce the wear rate.

In general, carbon fibers may have a length of at least 50 meters, and may be as long as a kilometer or more. Typically, continuous carbon fibers have an average fiber diameter ranging from approximately 4 micrometers to 12 micrometers. Carbon fibers are marketed under various trade names. For example, one suitable carbon fiber is from Zoltek Corporation of St. Louis, Mo., and has the trade name “Panex 35.” In an illustrative example, the fiber volume fraction is about 0.5-0.7.

Thermoset composites typically utilize heat applied over a length of time to induce a chemical reaction called cross linking Cross linking creates strength and stiffness in the “glue” that holds the laminate together. However, thermoplastics do not use a one way chemical reaction to achieve interlaminar strength. Thermoplastic composites utilize a repeatable two way process to provide interlaminar strength. The thermoplastic matrix may be in solid form at room temperature. The thermoplastic material may be heated to the melt temperature of the thermoplastic in order to allow shaping or contouring of the laminate. This may allow the laminate to conform to almost any shape. Thermoplastic composite resins, such as carbon fiber PPS, may provide a thermoplastic unidirectional tape or woven fabric materials that meet stringent flame, smoke, and toxicity (FST) requirements are necessary for aircraft interior applications.

The process disclosed in U.S. Publication No. US 2009/0101277 has been used in this industry and may be successful in high volume manufacturing of near flat shapes, however, the process may have little use in creating hollow or tubular structures, such as the seat back frame 74. The present method 10 may address this need for a finished product 74 that may accommodate geometries other than near flat shapes. A tubular shaped part may be preferred to carry the load for the frame 74. For example, a tubular shaped part may have a cross-section that may be square, rectangular, ovular, circular or the like.

In the illustrative non-limiting example, the finished product or seat back frame 74 formed from the method 10 may be able to pass specific testing conditions required by the airline industry (FIGS. 1-3 and 12-14). For example, the seat back frame 74 may be required to pass cyclic load tests. One test may require one leg 78 of the seat back frame 74 to be locked in place, whereby the other leg 78 may freely move or pivot. After locking one of the legs 78, the upper portion of the opposite or unlocked leg 78 may be pulled backwards, in a direction that may cause a seat back to recline. This backwards force is applied until 90 psi is reached. This test is performed for at least 50,000 cycles.

Another test that the seat back frame 74 may be required to pass may be similar to the first test, but may require the seat back frame 74 to be pulled in a rearward direction for a higher amount of cycles and until a higher pressure is reached. For example, the middle of the seat back frame 74 may be pulled in a rearward direction until a pressure of 168 psi is reached. This test is performed for at least 70,000 cycles. These tests verify that the seat back frame will not have any breaks, cracks or the like during the lifetime of an aircraft. These tests may also track how much the seat back frame bends or the angle of deflection from start to finish. The seat back frame 74 may also be required to pass a test where the frame 74 may be pulled on one time with 300 pounds of force and survive.

The seat back frame 74 may also be required to withstand certain dynamic testing, such as compliance with HIC and femur load requirements, such as the requirements of CS 25.562 according to Advisory Circular AC 25.562 from the FAA. The HIC is a measure of the likelihood of head injury arising from an impact. For example, the seat back frames 74 may be fitted on a test sled with crash test dummies. The sled may then be crashed into a wall to measure how much force the dummies heads incur when they slam into the seat in front of them.

Unlike traditional seat back frames that typically require a head pan, lumbar structural across the mid back of the seat frame, and the like, the seat back frame 74 does not require these additional structures. The seat back frame 74 fabricated by the method 10 may carry all of the load in the frame itself.

Typically, a thermoset tubular frame may have been used. In addition, the hollow tubular part of seat back frames 74 may often be difficult to manufacture as a square or rectangular shaped tube utilizing current processes. The present method 10 may provide for the manufacture of a bladder molded thermoplastic carbon fiber/PPS braided sleeve or sock 50 with a unique process. Numerous options have been investigated regarding process parameters (e.g., temperature, pressure, time, etc.) as well as bladder 54 selection, bladder fitting interface, and the like.

The method 10 may provide a robust manufacturing method for creating tubular structures, such as legs, seat frames, beams, armrests, backrests, tables, and the like, that may be used in commercial aircraft seat back frames. While discussed in terms of airline applications, it is to be understood that the present method 10 may be utilized in any appropriate industry to fabricate any appropriate type of product, whereby the available applications may be endless.

Thermoplastic carbon fiber (PPS) strands or threads may be used to make this tubular shaped part. Forming the sock out of thermoplastic PPS requires a very high temperature process. Previously, a square or rectangular tubular design could not be easily or cost effectively manufactured with all the desired qualities. As a substitute, two U-shaped parts were often manufactured and then attached together with a flange, which is not structurally ideal. In addition, adding a flange around the seat back perimeter may also add detrimental weight to the seat back frame 74.

The carbon fiber may come in a dry form comprising small threads of carbon fiber. Advantageously, the PPS may already be located or integrated into the sock threads. Plain carbon fiber threads may make a “tape” by laying several threads side by side with an epoxy resin already located on the threads. As an alternative, the epoxy may be brushed one or sprayed on. The thermoplastic carbon fiber material may be obtained with the epoxy already located therein.

Moreover, while the present method 10 may be described in the context of the airline industry and passenger seats, it will be appreciated that the method 10 may be used in a variety of contexts, and, as such, any reference to the airline industry or airline seats is illustrative in nature and not restrictive in any way. In addition, the method 10 may be utilized for making any other type of appropriate part or component, such as other structural tubular components to be used in any appropriate industry, for example. In addition, the description provided may refer to the use of specific materials, such as composites, however, this should not limit the scope of the invention as claimed. Those skilled in the art will understand that the following descriptions should only be taken as illustrative.

Although the embodiments of the present invention have been illustrated in the accompanying drawings and described in the foregoing detailed description, it is to be understood that the present invention is not to be limited to the embodiments disclosed, but that the invention described herein is capable of numerous rearrangements, modifications and substitutions without departing from the scope of the claims hereafter.

Having thus described the invention, the following is claimed:

1. A non-continuous thermoplastic-carbon fiber composite sleeve capable of being formed into a tubular product, said sleeve comprising:
at least one non-continuous thermoplastic fiber strand;
at least one carbon fiber interwoven with said at least one non-continuous thermoplastic fiber strand; and
wherein said carbon fiber is positioned at an angle different from the thermoplastic fiber strand.

2. The sleeve of claim 1, wherein said non-continuous thermoplastic fiber strand provides strength properties in a longitudinal direction of the non-continuous thermoplastic fiber strand.

3. The sleeve of claim 2, wherein said non-continuous fiber strand provides formability in different and varying directions.

4. The sleeve of claim 1, wherein said thermoplastic is polyphenylene sulfide (PPS).

5. The sleeve of claim 1, wherein said non-continuous thermoplastic fiber strands are braided at an angle relative to each other.

6. The sleeve of claim 5, wherein said non-continuous thermoplastic fiber strands are braided at a 45° angle.

7. The sleeve of claim 1, wherein said fiber strands are at about a 0° angle relative to each other.

8. A method for forming a tubular product, said method comprising:
weaving a plurality of non-continuous thermoplastic fiber strands with carbon fiber strands to form at least one sleeve to be processed;
positioning a bladder within said at least one sleeve creating a work piece;
placing said work piece in a mold;
heating said mold and said work piece;
pressurizing said bladder; and
removing said work piece from said mold.

9. The method of claim 8 further comprising adding PPS resin film to said mold prior to heating.

10. The method of claim 8 further comprising soaking said work piece in said mold after heating.

11. The method of claim 8, wherein said mold and said work piece are heated to about 600° Fahrenheit.

12. The method of claim 8, wherein said bladder is pressurized to about 80 psi.

13. The method of claim 10, wherein said work piece is soaked for about 10 minutes.

14. A tubular product fabricated from thermoplastic-carbon fiber composite, said tubular product comprising:
a braided sleeve comprising at least one non-continuous thermoplastic fiber strand interwoven with a carbon fiber strand at an angle different from said non-continuous thermoplastic fiber strand;
a plurality of sleeves interwoven at a first angle relative to each other;
a plurality of sleeves interwoven at a second angle relative to each other; and
at least one layer of said sleeves at the first angle layered with at least one layer of said sleeves at the second angle, wherein said layers form said tubular product.

15. The tubular product of claim 14, wherein said product includes a pair of legs.

16. The tubular product of claim 15, wherein one of said legs is locked in to place and an upper portion of the unlocked leg is pulled in a rearward direction with a backwards force until a pressure of at least 90 psi is reached for at least 50,000 cycles.

17. The tubular product of claim 14, further comprising a mid section capable of withstanding being pulled in a rearward direction until a pressure of at least 168 psi is reached for at least 70,000 cycles.
